(19) United States
(12) Patent Application Publication
(10) Pub. No.: US 2026/0346543 A1
(43) Pub. Date: Nov. 5, 2026

(54) A METHOD FOR PRODUCING AND USING A COMPLEX FLUID

(71) Applicant: RAYO 3D BIOTECH OY, Kalkkiranta (FI)

(72) Inventor: Pekka VALLITTU, Kuusisto (FI)

(21) Appl. No.: 19/488,149

(22) PCT Filed: Jun. 22, 2023
(86) PCT No.: PCT/EP2023/066954

§ 371 Date: Nov. 26, 2025

(51) Int. Cl. B29C 64/245; B29C 64/118; B33Y 30/00; B33Y 99/00; C09D 7/45

(52) U.S. Cl. CPC B29C 64/245; B29C 64/118; B33Y 30/00; B33Y 99/00; C09D 7/45

(57) ABSTRACT

Disclosed is a method for producing bubbly liquid material that is suitable for being used as a supporting material in a 3D printing system, the method comprising, producing to liquid material primary bubbles, stabilizing the primary bubbles with cross-linking enhancing compound, producing secondary bubbles to the liquid material, and using the liquid material comprising the primary and secondary bubbles as the supporting material for printing a 3D object, wherein the liquid material comprises a bubble system comprising at least the primary and secondary bubbles.

### FIELD

The present disclosure relates to producing bubbly liquid with complex fluid properties that is used in additive manufacturing.

### BACKGROUND

In fabrication of 3D printed objects with diversity of shapes there may be shapes, or part of shapes such as overhangs that may be critical overhangs, which cannot be balanced by the main body of the printable object and therefore printing material may collapse due to gravity. There are various attempts that may be used to overcome this issue, for example, printing the material in supporting bath and multichannel plotting by co-extrusion of temporary supporting material together with the main printing material. When supporting path is used, the Newtonian and non-Newtonian type liquids and gels have physical properties which under shear force by the movement of the injection head of the 3D printing device cause movement of the supporting material and stretching the printable material. This causes deformation and inaccuracy to the printable object. In addition, the liquid supporting material regardless of its possible high viscosity may not support the printable material enough against the effects of gravity when the density of the printable material is high for instance due to heavy filler particles.

It is a preferred property for the supporting material that it has liquid-like continuous phase in which the printing head moves but at the same time the continuous fluid phase needs to demonstrate plastic behavior when shear force is applied to the supporting material by movement of the printing head.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is a method and system for producing bubbly liquid material where Newtonian or non-Newtonian liquid material is transformed by jamming transition to bubbly liquid material having plastic deformation properties of a complex fluid. The bubbly liquid material produced may be used as supporting material for 3D printing in a 3D printing system.

In an example embodiment according to the first aspect, the bubbly liquid material is formed by producing to the liquid material primary bubbles. This may be achieved for example by adding surfactant to the Newtonian liquid and forming the primary bubbles to the liquid by physical means with aerator or shaking for having non-Newtonian type of liquid.

In the example embodiment according to the first aspect, the primary bubbles are stabilized with cross-linking enhancing compound. For example, the primary bubbles may be stabilized by adding free radicals, such as free radical comprising compounds, or other molecular compounds or nanofillers to the continuous liquid phase after which shaking forms secondary bubbles thus making the bubbly liquid complex fluid and additionally absorbs substances from the surrounding medium of the bubbly liquid.

Optionally, in the example embodiment according to the first aspect, tertiary bubbles are produced to the stabilized bubbly liquid material by chemical reactions or physical means of injecting gas to the bubbly liquid material for making the bubbly liquid material to comprise multi modal gas bubble system to have plastic deformation when shear force is applied.

In the example embodiment according to the first aspect the bubbly liquid material thus has a system of gas bubbles of one or several different gas compositions.

In the example embodiment according to the first aspect the gas bubbles may diminish buoyancy effect of the continuous liquid phase and by the surface tension on the gas bubbles may hinder effect of the force of gravity.

In the example embodiment according to the first aspect the multimodal bubble system may diminish the effect of Archimedes principle and holds the additional printing material vertically (y-direction) in the predetermined location.

In the example embodiment according to the first aspect, the stabilized continuous liquid phase of the bubbly liquid traps the gas bubbles inside of the bubbly liquid and hinders collapse and coalescence of the gas bubbles.

In the example embodiment according to the first aspect, the bubbly liquid with primary and secondary bubbles and the followed jamming transition influence firmness and stiffness of the bubbly liquid to be able to support additional materials in the bubbly liquid to be kept at desired x-y-z location and volumetric form.

In the example embodiment according to the first aspect, the additional materials in the bubbly liquid can transform their state of matter from fluid and fluid-like state to semi-solid and solid.

In the example embodiment according to the first aspect, the viscosity and state of matter transformation of the bubbly liquid can be changed by the primary, secondary and optional tertiary bubbles and co-existing chemical reactions in the bubbly liquid and by addition of nanoparticles or molecules for emulsion, suspension or colloidal systems.

### BRIEF DESCRIPTION OF THE DRAWINGS

FIG. 1 illustrates the bubbly liquid system with primary bubbles and printable material.

FIG. 2 illustrates the bubbly liquid system with primary and secondary bubbles and printable material.

FIGS. 3A and 3B illustrates collapse and runoff of the additional material due to the gravity and effect of bubbly liquid to resist the effect of gravity.

FIG. 4 illustrates static flow of the liquid of same composition without and bubbles.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only as to a single embodiment. Single features of different embodiments may also be combined to provide other embodiments.

A non-Newtonian liquid is characterized by a viscosity that varies with motion. Most non-Newtonian liquids have a molecular chain structure and are also complex fluids. Complex fluids are mixtures with two or several phases of solid-liquids (suspensions), solid-gas, liquid-gas (foams) or liquid-liquid (emulsions). Mechanical response of the complex fluid includes transitions between solid-like and fluid-like behavior including plastic deformation. Complex fluid with plastic deformation in shear can be for instance cut. Material of this kind is called Bingham plastic.

Bubbly liquid, which may also be referred to as bubbly liquid material, comprises continuous liquid phase and gas bubbles at circa 50 percentage. With higher gas bubble volumetric loading the material becomes a foam. Bubbles modify the rheology of the liquid by resisting deformation and liquid's behavior is affected by the properties of the continuous liquid phase and size bubble volume fraction. Surface tension of the bubbles balances the outward force of air pressure and the weight of the material inside the bubbly liquid by Laplace pressure. Bubbles are formed to the liquid when the amount of dissolved gas exceeds the limit of its solubility in the liquid and gas molecules join in aggregates which forms gas bubbles. Gas bubbles are floating up because of their low density unless the physical properties of viscosity and plasticity of the continuous liquid phase is not hindering floating by trapping the bubbles and thus stabilizing the bubbly liquid. Trapping of gas bubbles in the liquid is also influenced by friction which is known as drag or fluid resistance.

When additional material of object is placed to liquid the Archimedes principle allows the buoyancy of the floating object which is immersed in the liquid. Buoyant effect for the material or object is equal to the weight of the displaced liquid. However, if the liquid is filled with gas bubbles, weight of which is essentially less compared to liquid without gas bubbles, the buoyant effect is less. Balance between the buoyant effect, the effect of gravity and the surface tension of the gas bubbles holds the additional material and object in steady location in the liquid. The buoyancy effect can also be explained by collisions of water molecules to the floating object rather than weight of the displaced liquid. Also in this case, gas bubbles diminish number of water molecules and floating in foamy liquid will be less. It is also noteworthy to highlight the effect of surface tension i.e. the density difference between the liquid and gas phases which typically is effective on the surface of liquid letting light object to float. The density difference exists also inside of the liquid when there are gas bubbles present.

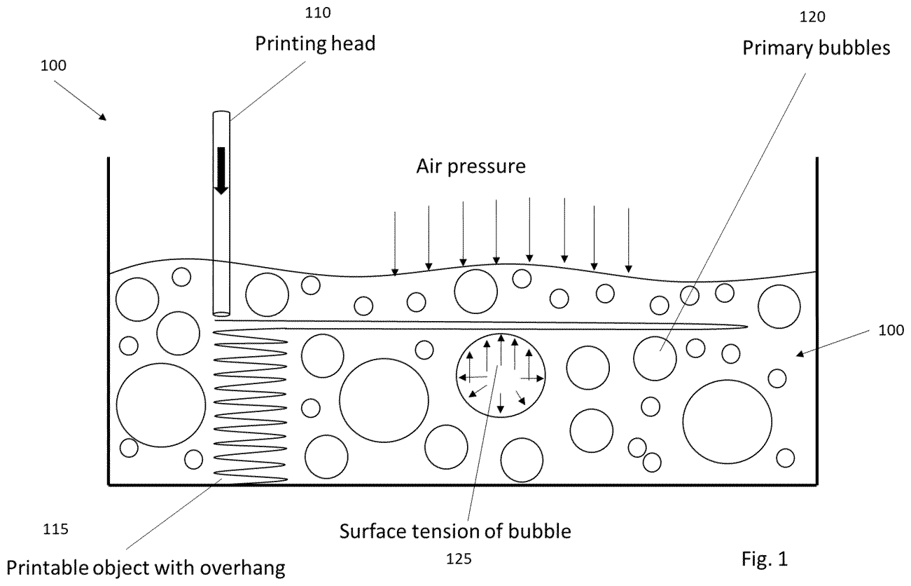

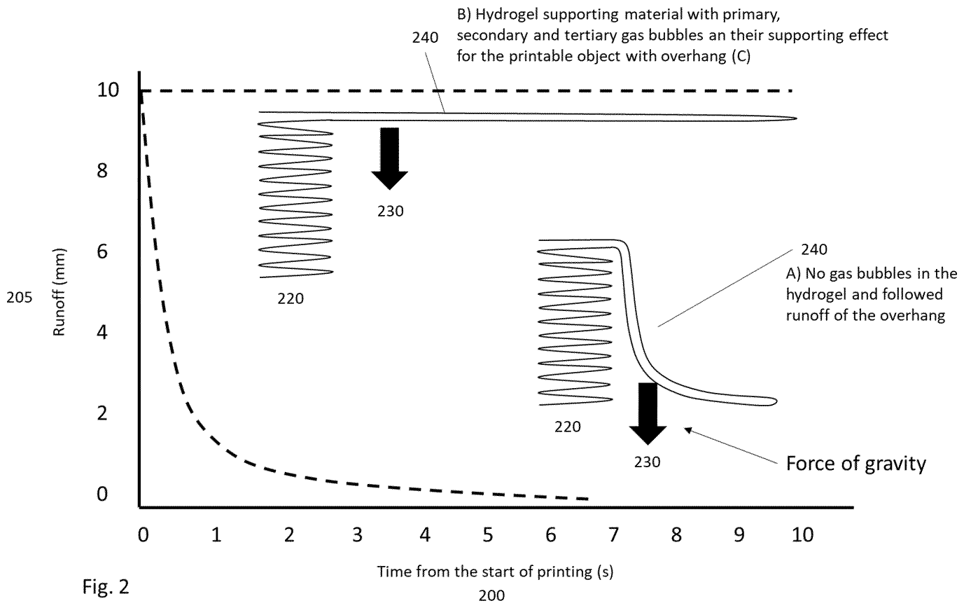

Gas bubbles can be produced using physical means, such as by using aerator or shaking the liquid, or by chemical reaction in the liquid material to produce gas. Continuous liquid phase is typically made from Newtonian liquid of water and by adding surfactant like soap to the water surface tension of water is lowered which increases foaming. Normal foam is unstable system and bubbles will disappear by time. If the surfactant is simultaneously increasing the viscosity of water and making the liquid complex fluid type decay time of the bubbles is prolonged or the bubbles are even trapped to the continuous liquid phase. Compounds which lower the surface tension of water and enhance formation of bubbles comprise for example methyl cellulose (C₆H₇O₂(OH)ₓ(OCH₃)_{y}), hydroxypropyl methyl cellulose (C₅₆H₁₀₈O₃₀) or chitin (C₈H₁₃O₅N)ₙ). Methyl cellulose hydrogel can be aerated for air bubbles by aerator or shaking. For initial stabilization of the methyl cellulose hydrogel for trapping air bubbles, methyl cellulose macromolecules affinity to react with each other for cross-linking is enhanced by free radical forming compound in the methyl cellulose water liquid. One example of cross-link enhancing compound is 4,4′-Azobis (4-cyanopentanoic acid) which spontaneously at RTP forms minor quantities of hydroxyl radicals to the liquid. Another example of cross-linking enhancing compound is silyl glyoxylates. Other cross-linking agents for cross-linking methyl cellulose are epichlorohydrin, aldehyde-based reagents, urea derivates and multifunctional carboxylic acids like citric acid. In cross-linking chain co-polymerization reactions with the vinyl group of the methyl cellulose takes place in the presence of water and hydrogel begins to form. Air bubbles in slightly cross-linked hydrogel may be called as primary bubbles. FIG. 1 illustrates as example of such primary bubbles 120 in bubbly liquid material 105 that is to be used produced to be used as supporting material for 3D printing. The primary bubbles 120 may be of diameter 0.1 to 1.0 mm for example (FIG. 1). Quantity of methyl cellulose can be between 1 to 20 wt % of the weight of the water, preferably 5 wt %. Surface tension 125 of the air bubbles and the density difference of gas and liquid balances the outwards force of air pressure and supports the printable material extruding from the printing head 110, which is used for 3D printing in the 3D printing system 100, and forming the printable object 115 from run off by the force of gravity. Although non-Newtonian type hydrogel can keep the air bubbles in the gel for a longer period of time than the Newtonian, water hydrogel is not completely trapping the gas bubbles and they will disappear by time when the hydrogel is stored or used as supporting material for 3D printing material. Thus, the overhangs will collapse by the force of gravity already less than one second after injecting of the resin material had started before becoming polymerized, which is illustrated in FIG. 2. In FIG. 2 there is a chart in which the y-axis illustrates runoff (mm) 205 and the x-axis illustrates time from the start of printing 200. The printing may be performed using a 3D printing system such as the printing system 3D. In general, a 3D printing system comprises a printing head configured to inject the printing material into the supporting material, that may be bubbly liquid. The printing may be controlled by a controlling unit coupled to the printing head using any suitable mechanism for the coupling. It is also to be noted that controlling the printing may be performed, at least partly, using computer program instructions. In FIG. 2, the force of gravity 230 affects an overhang of the object that is printed. In the scenario 240, a printed object 210 has an overhang 215. In this scenario, there are no gas bubbles in the hydrogel used as the supporting material and as a result, there is the runoff of the overhang 215. In the scenario 250, the object 220 is printed and it has an overhang 225. In this scenario the hydrogel supporting material with primary, secondary and tertiary gas bubbles provide a supporting effect for the overhang 225. To stabilize and increase viscosity of the bubble liquid to trap air bubbles additional compounds like cellulose nanocrystals (CNC), or other polysaccharides such as sucrose or fructose can be added to the hydrogel. When sucrose is used for stabilization of the bubbles sugar content can be 10-150 weight percent of the weight of water, preferably 80 wt %. By further shaking the hydrogel with additional compound of secondary air bubbles are formed to the hydrogel with simultaneous increase in the viscosity ja jelling transformation to complex fluid. Other molecular compounds and nano sized fillers like graphene, silica, zirconia, alumina can be added to the bubbly liquid of hydrogel for increasing the viscosity and for causing the jelling transformation.

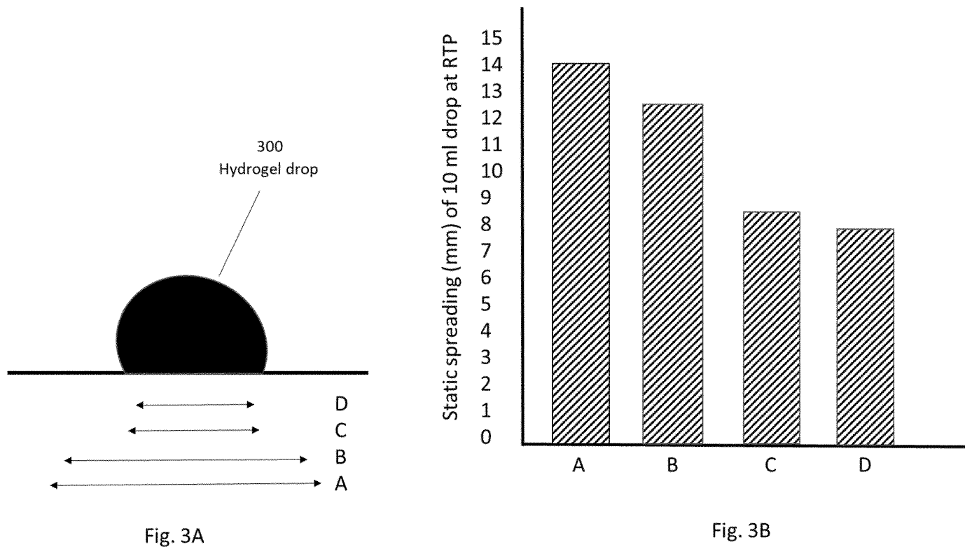

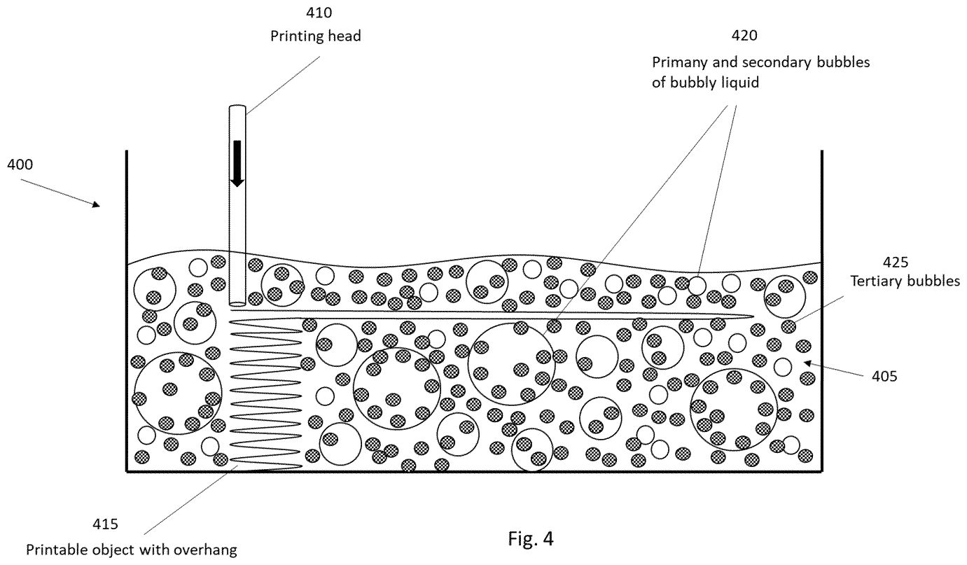

Complex fluid properties and homogeneity of the hydrogel may be enhanced by tertiary gas bubbles which can be nitrogen gas (N₂) comprising bubbles of for example 0.01 to 0.1 mm in diameter. The effect of secondary and tertiary gas bubbles for the static flow of 10 ml hydrogel drop 300 on glass plate is demonstrated in an example illustrated in FIGS. 3A and 3B as measured of spreading the hydrogel drop at room temperature and pressure (RTP) in 20 minutes time (FIG. 3A). Grouping A to D with the same composition of methyl cellulose and sucrose refers the following: A: No primary, secondary and tertiary bubbles; B: with tertiary bubbles; C: with primary and secondary bubbles; D: with primary, secondary and tertiary bubbles with arrowheads showing schematically the width of the drop after 20 minutes. FIG. 3B shows that spreading of hydrogel with same composition but with different gas bubble structure behave differently in their flow properties. A source for the tertiary gas bubbles, which may have a function of protection gas like N₂, argon (Ar) for enhancing free radical polymerization by eliminating the oxygen inhibition effect of free radical polymerization of the printable resin material because of diffused oxygen in the hydrogel, is chemical reaction in the hydrogel or injecting gas into hydrogel. The tertiary gas bubbles increase homogeneity of the hydrogel and also fill the large size primary air bubbles. This is illustrated in FIG. 4 in which there are tertiary bubbles 425 comprised in supporting material 405. The supporting material is used with the printing system 400, in which there is a printing head 410, that injects printing material into the supporting material 405 to produce a 3D printed object 415 comprising an overhang. The supporting material 405 also comprises primary and secondary bubbles 420. The printing system in 400 in this example embodiment may further comprise a control unit configured to control the movement of the printing head 410 as well as injection of the printing material. The controlling may be achieved using suitable mechanical structured and software to control the 3D printing process. Having the tertiary bubbles 405 improves surface smoothness of the printable object 415 if the hydrogel is used as supporting material 405 for the 3D printed object 415 with the overhang. The bubble system of the complex fluid with its consistency and plastic deformation provides support for the resin material used as the printing material and which is 3D printed to the hydrogel used as the supporting material 405 and eliminates material runoff due to force of gravity, the effect of which was illustrated in FIG. 2.

Other hydrogels than methyl cellulose can also be adjusted for becoming complex fluid by adding sucrose molecules or some other molecules. Non-ionic polyacrylamide (PAM) ((C₃H₅NO)ₙ)— water hydrogel (PAH), cellulose micro fibrils, cellulose nanocrystals, potassium salt, chitosan, alginate, polyvinyl alcohol, starch, gelatin water hydrogels can be used in the similar manner as sucrose for the application of 3D printing supporting material or bioink. Biodegradable hydrogels are natural-based hydrogels like polysaccharides (e.g. chitosan), starch, gelatin, alginate and proteins (e.g. collagen), or synthetic such as poly(lactic acid) (PLA), poly(glycolic acid) (PGA) and polypropylene fumarate (PPF).

Complex bubbly liquid is useable in 3D printing, for example, as supporting material but can be utilized also in fields where the compounds and nanofillers of the bubbly liquid can adsorb and remove non-desired inorganic materials like metals, heavy metals metalloids and organic materials like dyes, agrochemicals or trace contaminants from water or soil, or in food industry to modify consistency of food. In applications of this kind, the liquid with graphene, cationic polymers or aluminium sulfate are poured or applied to the substance to be cleaned and the chemical reactions to produce hydrogel stabilizing free radicals is taking place by radiation from sunlight or by specifically designed radiator device. Before the stabilization takes place the contaminants are adsorbed by graphene, cationic polymers or aluminium sulfate and can be removed by removing the complex fluid. In water cleaning, the control of the buoyancy effect by the primary, secondary and tertiary bubbles and having space for contaminants in the three-dimensional bubble structure enhance removal of nondesired substances.

1. A method for producing bubbly liquid material that is suitable for being used as a supporting material in a 3D printing system, the method comprising:
producing to liquid material primary bubbles;
stabilizing the primary bubbles with cross-linking enhancing compound;
producing secondary bubbles to the liquid material; and
using the liquid material comprising the primary and secondary bubbles as the supporting material for printing a 3D object, wherein the liquid material comprises a bubble system comprising at least the primary and secondary bubbles.

2. A method according to claim 1, wherein method further comprises causing jamming transition to the liquid.

3. A method according to claim 1, wherein producing the primary bubbles comprises:
adding surfactant to the liquid material and the liquid material is Newtonian or non-Newtonian liquid material; and
shaking the liquid material or using an aerator.

4. A method according to claim 1, wherein stabilizing the primary bubbles comprises adding free radicals, molecular compounds or nanofiller to continuous liquid phase of the liquid material.

5. A method according to claim 4, wherein producing the secondary bubbles comprises shaking.

6. A method according to claim 1, wherein the method further comprises producing tertiary bubbles, wherein the tertiary bubbles by causing a chemical reaction or by injecting gas to the liquid material.

7. A method according to claim 1, wherein the tertiary bubbles are comprised in the bubble system and the bubbles in the bubble system are of one or several different gas compositions.

8. A method according to claim 7, wherein the primary bubbles comprise air, and/or the tertiary bubbles comprise nitrogen gas.

9. A method according to claim 1, wherein the liquid material is hydrogel.

10. A system for 3D printing, wherein the system comprises at least a printing head configured to inject printing material to form a 3D printed object, wherein the system further comprises controlling the 3D printing by a controlling unit, the system being configured to inject the printing material into supporting material that is produced using a method according to claim 1.
